(19) United States
(12) Patent Application Publication
(10) Pub. No.: US 2005/0047731 A1
(43) Pub. Date: Mar. 3, 2005

(54) Packaging assembly for optical subassembly

(75) Inventors: Charles Hu, San Francisco, CA (US); Paul Rosenberg, Sunnyvale, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 10/832,699

(22) Filed: Apr. 27, 2004

Related U.S. Application Data
(60) Provisional application No. 60/498,151, filed on Aug. 27, 2003.
(60) Provisional application No. 60/498,272, filed on Aug. 27, 2003.
(60) Provisional application No. 60/553,770, filed on Mar. 17, 2004.

(51) Int. Cl. G02B 6/36

(52) U.S. Cl. 385/92

(57) ABSTRACT

A compact packaging assembly is disclosed. In one embodiment, the compact packaging assembly includes a header can and a header structure which can be actively aligned. The header can is configured to house a window and/or lens. The header structure includes an optical device, and, optionally, an active temperature control device. The packaging assembly can be connected to a nose assembly without requiring additional components to connect thereto.

### RELATED APPLICATIONS

The present application claims priority to and benefit of U.S. Provisional Patent Application Ser. No. 60/498,151 filed Aug. 27, 2003 titled “Method for Optically Aligning Laser Assembly With Housing,” and U.S. Provisional Patent Application Ser. No. 60/498,272 filed Aug. 27, 2003 titled “Fabrication and Optical Alignment Device.” The present application is related to U.S. patent application Ser. No. 10/101,260 filed Mar. 18, 2002 titled “Compact Packaging assembly With Integrated Temperature Control,” which claims priority to U.S. Provisional Patent Application Ser. No. 60/317,835 filed Sep. 6, 2001. In addition, the present application is also related to U.S. Provisional Application Ser. No. 60/553,770, filed Mar. 17, 2004, titled “Nose Assembly for Optical Device.” All of these applications are incorporated herein in their respective entireties by this reference.

### BACKGROUND OF THE INVENTION

1. The Field of the Invention

The present invention relates generally to optical components, and more particularly, to a compact packaging assembly having a header can and a header structure.

2. The Related Technology

The use of optic networks has become increasingly important in the recent years. As such, extensive research and development has been dedicated to improving optical electronic systems. Various optical devices provide the functionalities for an operational optical system. Optical device include, but are not limited to, lasers, receivers, diodes, and the like. Optical devices for use in optoelectronic subassemblies or assemblies are generally provided in package form. One common package known in the art is a TO-can or TO package.

Besides the optical device itself, various other components can be added to the TO package for various reasons. For example, temperature control components can be added which include, but are not limited to, active temperature control devices (e.g., thermoelectric coolers), resistors, photodiodes, capacitors, and the like.

In order for an optical device to operate properly, it should be accurately aligned with the other optical devices (e.g., lenses, windows, waveguides or optical fibers). However, as the alignment requirements of opto-electronic devices become more stringent, existing alignment techniques often result in variations that exceed required tolerances, resulting in waste and low yields. It would thus be an advantage to be able to actively align an optical package before it is assembled so as to ensure accurate alignment and operation of the optical package.

Furthermore, connecting traditional TO packages to other components to form an optical subassembly can require additional components and steps. As shown in FIG. 1, an optical subassembly is configured to connect to an optical package. The optical subassembly 10 includes a nose assembly 12, a housing 14, and a traditional TO package 16. The nose assembly 12 is connected to one end of the housing 14. The nose assembly 12 is configured to receive the end of an optical fiber. Within the housing 14 is an isolator 18, a collimating lens 20, and header can of TO package 16. The base of the TO package 16 can also be disposed in the housing 14. The base of the TO package 16 is exposed from the housing 14 so that the leads can be connected to a printed circuit board or other electrical structure. As can be shown in FIG. 1, the housing 14 and nose assembly 12 are two distinct structures which requires additional components and additional processing steps to connect to each other. In addition, the end of the housing 14 must be configured to house the header can of the TO package 16 and subsequent steps are required to secure the header can thereto. Conventional header cans of TO packages are usually stamp formed from materials such as cobalt alloy. Thus, it would be an advantage to be able to reduce the number of steps and components required to form optical subassemblies.

Accordingly, there exists a need for a compact, pluggable, low power consuming package having a high degree of alignment accuracy.

### BRIEF SUMMARY OF AN EXEMPLARY EMBODIMENT OF THE INVENTION

An embodiment of the present invention is a packaging assembly for a transceiver or transmitter optical sub-assembly that includes a header can and a header structure. The header can is configured to house a window and/or lens and, optionally, an isolator. The header structure includes an optical device and, optionally, an active temperature control device. The header can and a header structure may be actively aligned in such a way prior to bonding so as to increase yields and reduce waste. In a typical transmitter optical sub-assembly, the optical device, lens or window, and optical fiber are aligned in a straight line for the best performance.

The compact packaging assemblies of the present invention are configured to combined with a nose assembly to form an optical subassembly. The optical subassembly can, in turn, be utilized in optoelectronic transceiver or transmitter modules that meet standardized form factor requirements. The packaging assembly is configured to be directly connected to the nose assembly without requiring additional component or processing steps. Thus, the present invention reduces the time and cost of manufacturing while enhancing the likelihood that the optical subassembly will be operational by actively aligning components before joining them.

These and other aspects, features and advantages of the present invention will become more fully apparent from the following description of the preferred embodiments and appended claims.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a fragmentary perspective view of a conventional optical subassembly, illustrating a conventional TO package;

FIG. 2 is a perspective view of a packaging assembly illustrating a header can and header structure prior to active alignment and bonding;

FIG. 3 is a perspective view of the packaging assembly of FIG. 2, illustrating the header can and header structure after alignment and fully assembled;

FIG. 4 is a cross sectional view of the assembled packaging assembly of FIG. 3 after active alignment;

FIG. 5 is a perspective view of the header subassembly of FIG. 2;

FIG. 6 is a side view of the header subassembly of FIG. 2;

FIG. 7 is a top view of the header subassembly of FIG. 1;

FIG. 8 is a perspective view of an active temperature control device of FIG. 5; and

FIG. 9 is a perspective view of the packaging assembly of FIG. 2 connected to a TOSA assembly via a nose assembly.

### DETAILED DESCRIPTION OF EXEMPLARY EMBODIMENTS

A detailed description of the invention will now be provided with specific reference to figures illustrating exemplary embodiments of the invention. It will be appreciated that like structures will be provided with like reference designations. Generally, the present invention is directed to packaging assemblies 100 which are configured to connect directly to an optical subassembly (e.g., a TOSA or a ROSA). Further, the packaging assemblies 100 are actively aligned to ensure correct operation of the resulting optical assembly.

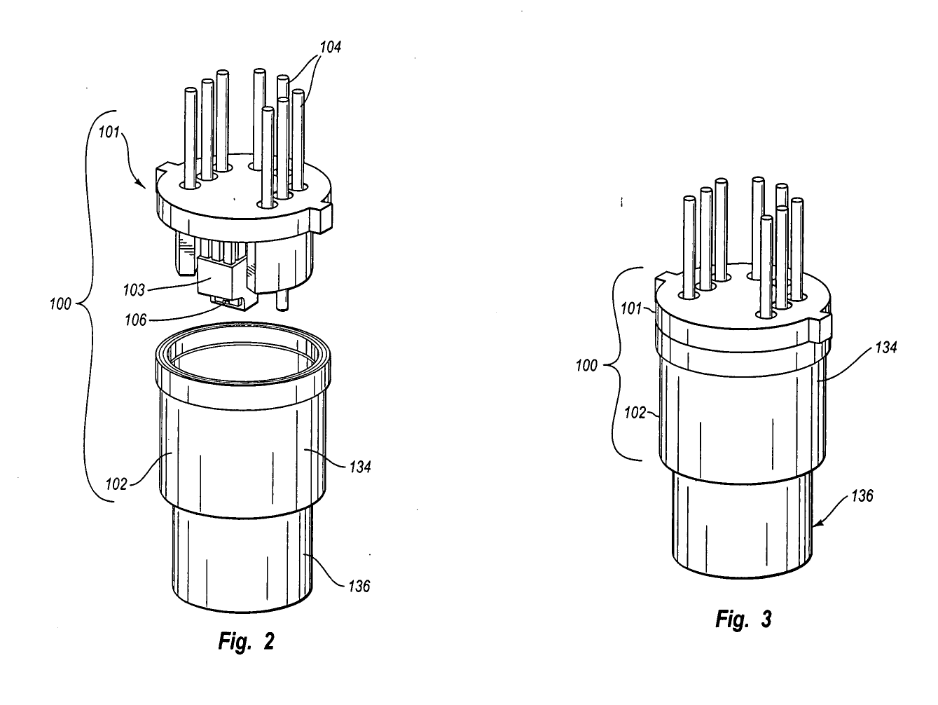

As shown in FIGS. 2 through 4, an exemplary packaging assembly 100 is illustrated incorporating features of the present invention. The packaging assembly 100 includes a header structure 101 and a header can 102. The header structure 101 and header can 102 can be actively aligned before assembly. Additional features may be provided to assist in the active alignment of the packaging assembly 100 as will be discussed in further detail below.

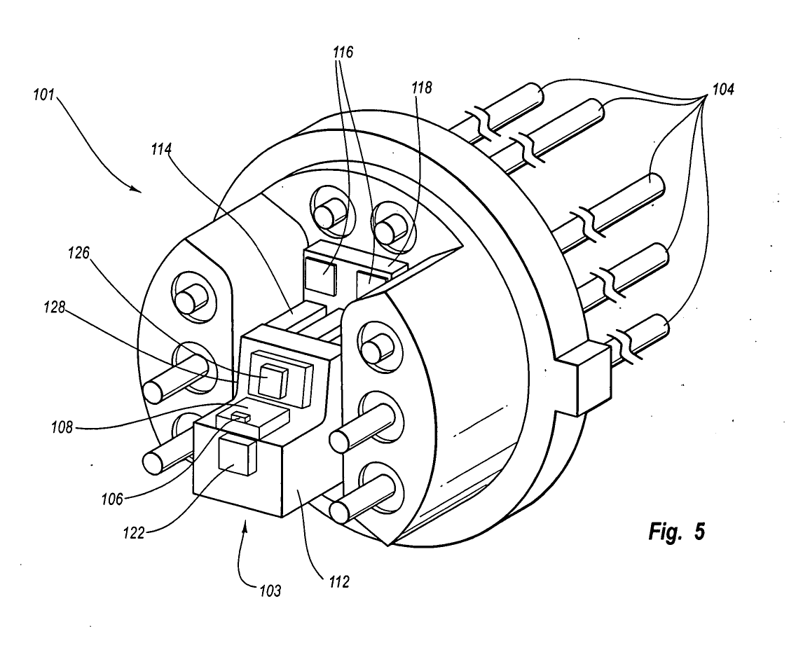

FIGS. 5, 6 and 7 are respectively a perspective view, a side view and a top view of a header structure 101 in accordance with an embodiment of the present invention. The header structure 101 is configured to mate with a header can 102, a perspective view of C which is illustrated in FIG. 2. In the present embodiment, the header can 102 and the header structure 101 together form the housing of, in one example, a packaging assembly.

According to one embodiment, the header can 102 and header structure 101 are configured so as to facilitate actively aligning the parts. In order to produce an optical device whose components are properly aligned, such as the packaging assembly 100 for example, the header structure 101 is actively aligned with the header can 102 prior to attachment of the two parts to each other.

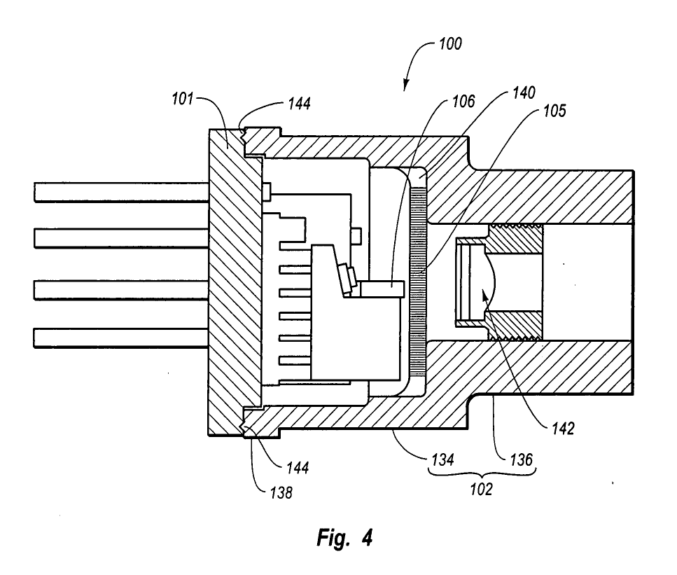

In one embodiment, the optical device is a laser emitter 106. The header structure 101 is shaped to receive an active temperature control device 103. A laser emitter 106 (e.g., a laser diode) is mounted to the active temperature control device 103 via a laser submount 108. The laser submount 108 is preferably made of aluminum nitride or silicon, and the laser submount 108 may incorporate one or more integrated passive components, such as resistors, capacitors, and inductors, to provide improved impedance matching and signal conditioning. Significantly, the laser emitter 106 is positioned and aligned with the window 105 of header can 102 (see FIG. 4) such that optical signals generated by the laser emitter 106 are aimed at and transmitted through the window 105 and eventually into an optical fiber (not shown). In the illustrated embodiment, the laser emitter 106 is positioned approximately at the center of the header subassembly and close to the window 105.

In one embodiment, the laser emitter 106 is an edge emitter. In alternative embodiments, a Vertical Cavity Surface-Emitting Laser (VCSEL) or any other suitable source of optical signals may be used. As is understood by one skilled in the art, an edge emitter laser emits optical signals in both the forward direction and the backward direction. Forward direction refers to the direction in which the optical signals have the strongest intensity, while backward direction refers to the opposite direction. The laser intensity in the backward direction is proportional to the laser intensity in the forward direction. Thus, it may be useful to measure the intensity of the laser in the backward direction in order to track the laser intensity in the forward direction. Accordingly, a photo-diode 126 may be positioned to sense the intensity of the optical signals emitted by the laser emitter 106 in the backward direction. The photo-diode 126 may be attached to the active temperature control device 103 via a photo-diode submount 128. The temperature of the photo-diode 126 is regulated by the active temperature control device 103. Thus, temperature sensitive fluctuations in the light intensity measurements made by the photo-diode 126 can be substantially eliminated.

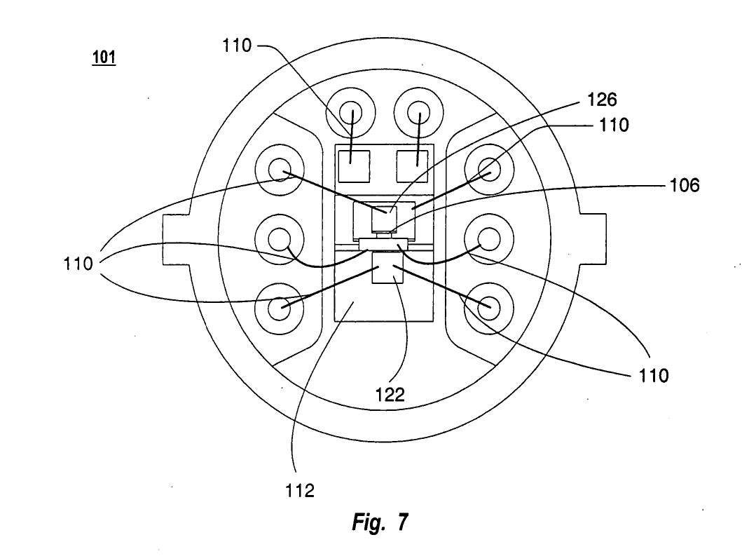

Also shown in FIGS. 5, 6 and 7 is a thermistor 122. The thermistor 122, which is operable to measure the temperature of the laser emitter 106, is preferably mounted to a top portion 112 of the active temperature control device 103, at a position that is close to the laser emitter 106. Temperature measurements from the thermistor 122 are communicated through bond wires 110 (FIG. 7) and leads 104 (FIGS. 3 and 4) to an external control circuit (outside the housing), which in turn adjusts the control signals to the active temperature control device 103. Specifically, depending on the temperature of the laser emitter 106, the control circuit sends appropriate control signals to drive an appropriate amount of electric current through the active temperature control device 103 to control the direction and amount of heat flow. A control circuit that may be used in conjunction with the present invention is described in U.S. patent application Ser. No. 10/101,248 entitled “Control Circuit for Opto-Electronic Module With Integrated Temperature Control,” hereby incorporated by reference.

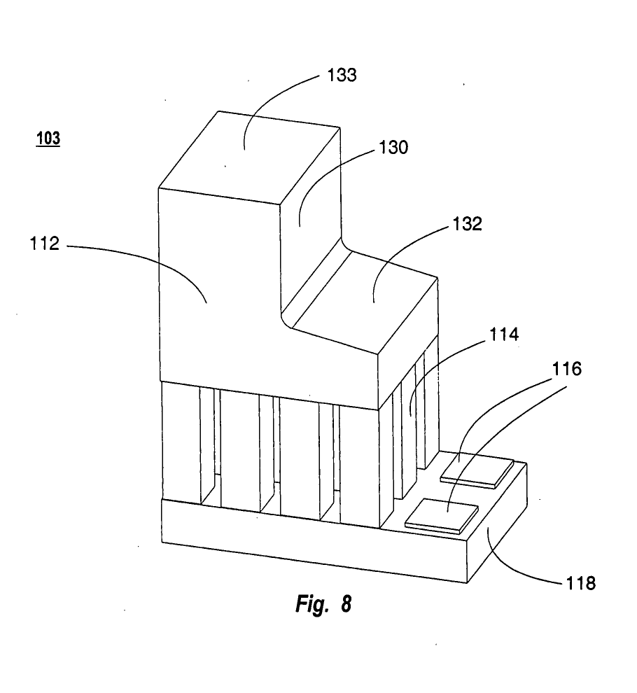

Referring now to FIG. 8, a perspective view of the active temperature control device 103 according to one embodiment is illustrated. As depicted, the active temperature control device 103 includes a base 118, a top portion 112 with an approximately L-shaped cross-section, and a plurality of thermoelectric elements 114 disposed between the base 118 and the top portion 112. The base 118 has two bond pads 116 that are coupled electrically to the thermoelectric elements 114 and to two of the package leads 104 to allow external control signals and power to be provided to the thermoelectric elements 114. The top portion 112 has a surface 130 that is approximately perpendicular to the base 118 and two surfaces 132 and 133 that are approximately parallel to the base 118. According to one embodiment, the laser emitter 106 is mounted on the surface 130 via laser submount 108, the thermistor 122 is mounted on the surface 133, and the photo-diode 126 is mounted on surface 132 via photo-diode submount 128. The thermoelectric elements 114 are configured to transfer heat from the top portion 112 to the base 118, or vice versa, depending on the direction of electric currents (provided via bond pads 116) that are driven through these thermoelectric elements 114. In one particular embodiment, the top portion 112 and the base 118 are passive heat sinks made of a ceramic material that may include beryllium oxide (BeO). Furthermore, in one particular embodiment, the thermoelectric elements may be made of a material that includes Bismuth Telluride (Bi₂Te₃). In one embodiment, the leads 104 may be made of Kovar (a composition that includes iron, nickel, cobalt, and small quantities (typically less than about 1%) of manganese, silicon, aluminum, magnesium, zirconium, titanium and carbon). Kovar is a trademark of Westinghouse Electric & Manufacturing Company.

With reference back to FIGS. 5, 6 and 7, the header structure 101 includes multiple leads 104 for connecting components inside the packaging assembly 101 to the exterior of the packaging assembly. Note that some of the leads 104 are longer than others such that short bond wires can be used. For instance, two relatively shorter leads are used to couple to the bond pads 116, which are located at the base 118. Two medium length leads are configured to couple to the photo-diode 126, which is mounted farther away from the base 118 than the bond pads 116. Four relatively longer leads are configured to couple to the laser emitter 106 and the thermistor 122, which are located even farther away from the base 118 than the photo-diode 126.

In one embodiment, the header structure 101 may be made by metal injection molding (MIM). The material used for making the header structure 101 should be suitable for MIM, resistance welding to the header can, glass sealing of leads for hermiticity, and plating. In addition, high thermal conductivity is desired. While many materials meet the aforementioned requirements, cold-rolled steel is presently preferred. Examples of other materials that may be used include “Alloy 42,” which is an alloy of nickel and iron, or Copper Tungsten (CuW) alloys.

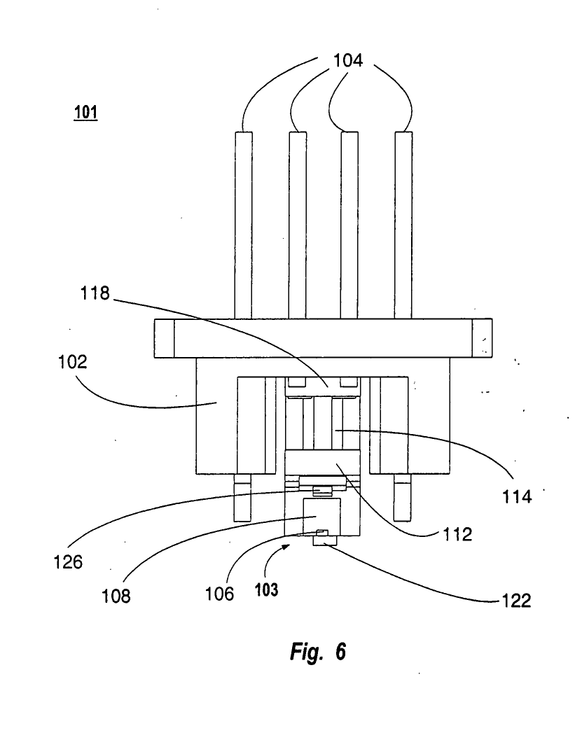

Bond wires 110, which are not shown in FIGS. 5 and 6 to avoid obscuring aspects of the invention, are illustrated in FIG. 7. Specifically, in the illustrated embodiment, a pair of the bond wires 110 connect the laser emitter 106 and the laser submount 108 to two leads 104, another pair of the bond wires 110 connect the thermistor 122 to two of the leads 104, another pair of bond wires 110 connect the photo-diode 126 and the photo-diode submount 128 to two of the leads 104, while yet another pair of bond wires 110 connect the bond pads 116 to the leads 104. In an alternative embodiment, bond wires 110 do not directly connect the laser emitter 106 to the leads 104. In such an embodiment, bond wires 110 connect the laser submount 108 to the leads 104. One terminal of the laser emitter 106 is in direct contact with the laser submount 108, and another terminal of the laser emitter 106 is connected to the laser submount via another bond wire.

In present embodiments, the bond wires 110 are preferably made of gold with diameters of about 1/1000 of an inch. The lengths of the bond wires 110 are preferably as short as possible so that they can transmit data at a high rate. The impedance of the bond wires may be matched to those of the leads 104 so as to avoid signal-reflections.

It will be appreciated that header structure 101 may have various other configurations depending on the type of optical device formed thereon. Further, additional components of header structure 101 may have various configurations, such as, but not limited to, the active temperature control device 103. For example, one possible alternative embodiment of active temperature control device is illustrated in more detail in U.S. patent application Ser. No. No. 10/101,260 filed Mar. 18, 2002 titled “Compact Packaging assembly With Integrated Temperature Control,” which is incorporated herein by reference.

Referring back to FIG. 2, a perspective view of header can 102 is depicted. In one embodiment, the header can 102 includes a body preferably made of stainless steel 304L. As illustrated in FIG. 2, in one configuration body of header can 102 includes portions having different diameters. That is, header can 102 has a first portion 134 with a larger diameter than a second portion 136. First portion 134 can be formed contiguously with second portion 136. In one embodiment, first portion 134 and second portion 136 can be formed integrally. In another embodiment, first portion 134 and second portion 136 can be formed from discrete parts which are bonded together using suitable bonding means such as, but not limited to, welding, soldering, adhesive, and the like. In addition, end of first portion 134 can include a stepped annular lip 138 which has a slightly larger diameter than first portion 134.

In one embodiment, first portion 134, second portion 136 and annular lip 138 have a substantially cylindrical cross-section. However, first portion 134, second portion 136 and/or annular lip 138 may have any of various cross-sections such as, but not limited to, oval, polygonal, and the like. In one embodiment, the cross-section of the first portion 134 and/or second portion 136 is selected based on the shape of the component to which the header can 102 is connected. However, as will be discussed below, this is not necessary because the novel configuration of the present invention does not depend on the second portion 136 of header can 102 conforming to any particular shape as is found in conventional packaging assemblies. It will be appreciated that header can 102 may have more or less portions having different diameters as necessary.

In one embodiment, header can 102 is constructed of stainless steel 304L. Stainless steel 304L can be easily processed using know machining processes to form body of header can 102. Advantageously, this allows header can 102 to be easily machined into the desired shape. In embodiments where the header can 102 is formed of stainless steel 304L, this can reduce the number of parts required to connect the packaging assembly 100 to the optical subassembly and can, in some cases, even reduce the size of the optical subassembly and, thus, the resulting module. In addition, stainless steel 304L can be laser welded, is non-magnetic, and is corrosion resistant. Furthermore, stainless steel 304L assists in forming hermetic glass solder bonds with window 105 (see FIG. 4) and the header structure 101. However it will be appreciated that header can 102 can be constructed of any material which provides these foregoing functions.

As shown best in FIG. 4, a window 105 may be situated inside the header can 102 between the first portion 134 and second portion 136. Because the second portion 136 can have a smaller diameter, this may assist in bonding the window 105 to header can 102 by providing a wall against which the window may be bonded. The window 105 can be disposed approximately at the center of the header can 102 to transmit optical signals emitted by the laser emitter 106. The window 105, in one embodiment, includes a piece of ultra flat, thin glass with a thickness of about 0.008 inch. The window 105 is preferably glass soldered as indicated by solder points 140 in FIG. 4 or otherwise bonded to the inside of header can 102 to form a hermetic seal and is preferably coated with an anti-reflective coating. In one embodiment, a Schott glass solder process is used to bond the window 105 to the inside of header can 102.

It will be appreciated that portions 134 and 136 of the header can 102 may be resized (i.e., made shorter or longer) so as to position the window 105 closer or farther away from header structure 101. For example, placing the laser emitter 106 close to the window 105 provides greater flexibility in designing compact, efficient coupling optics between the laser emitter 106 and external optical fibers.

In one embodiment, shown best in FIG. 4, a lens 142 is disposed in the second portion 136 of header can 102. Optical signals emitted by the laser emitter 106 pass through window 105 and then through lens 142. The lens 142 serves to focus and collimate the optical signal generated by the laser emitter 106. While the above embodiments have described packaging assemblies having a window or a lens, it will be appreciated that the packaging assemblies of the present invention may have any combination of window and/or lens according to design requirements.

FIGS. 2, 3 and 4 illustrate the assembly of the header structure 101 to the header can 102 to form packaging assembly 100. As mentioned above, it is desirable that the header can 102 and the header structure 101 be actively aligned before they are sealed or otherwise joined. Active alignment can be beneficial for optical packages having either a window or a lens, or both. In general, “active” alignment refers to processes whereby power is transmitted to the optical transmitter component (e.g., laser) through a window and/or lens and the resulting optical signal generated is used to align the optical transmitter component with the window and/or lens.

Alignment of the lens to the laser can be important because precise alignment results in improved capture of the optical signal generated by the laser. The combination of active alignment of the laser emitter 106 with the lens 142, and the collimating effect of the lens 142 aids the optical signal in being properly introduced into an optical fiber attached to the device.

In one embodiment, the laser emitter 106 and window 105 and/or optical fiber are aligned in a substantially straight line for the best performance. In this embodiment, the laser emitter 106 is affixed to the active temperature control device 103 and actively aligned such that optical signals generated by the laser emitter can be emitted through the window 105 without a waveguide.

As shown in FIG. 4, to facilitate active alignment, the header can 102 and/or header structure 101 may include projections on their mating surfaces so that they may be joined by projection welding. For example, as depicted in FIG. 4, the header can 102 can include projection 144 formed on the surface of annular lip 138 of header can 102 which is configured to mate with the header structure 101 to facilitate alignment. In one embodiment, projection 144 may be in the form of an annular projection ring which corresponds to the shape of the annular lip 138. In other configurations, the projection 144 may include a plurality of projections formed on the annular lip 138 which is configured to mate with the header structure 101. Projections 144 provide for resistance projection welding of the parts. Projection welding of the parts, after active alignment, is one method of joining the header can 102 with the header structure 101.

While the particular method for actively aligning the packaging assemblies of the present invention is not essential for purpose of this invention, in one exemplary implementation of the alignment method, power is provided to the laser, causing the laser to generate an optical signal which is then directed through the window and/or lens. As the optical signal passes through the window and/or lens, a camera with a zoom lens receives an image of the positioning of the laser relative to the window and/or lens. The position of the header structure and header can are then adjusted relative to one another so as to cause their alignment to be within a desired tolerance range, at which point the header structure and header can be joined together by a suitable process such as resistance projection welding, for example. A method of actively aligning the parts of the housing is described in U.S. Provisional Patent Application Ser. No. 60/498,151, filed Aug. 27, 2003, entitled “Method of Optically Aligning Laser Assembly With Housing,” already incorporated above by reference.

While the particular system or mechanism for actively aligning the packaging assemblies of the present invention is not essential for purposes of this invention, in one exemplary embodiment, a fabrication and optical alignment device for implementing a method for actively aligning the header structure includes, among other things, a frame, a mounting and alignment assembly, and a camera. Suitable mechanisms and systems for performing the function of actively aligning the header can with the header structure are disclosed in U.S. Provisional Patent Application Ser. No. 60/498,272, filed Aug. 27, 2003 and entitled “Fabrication and Optical Alignment Device,” already incorporated above by reference.

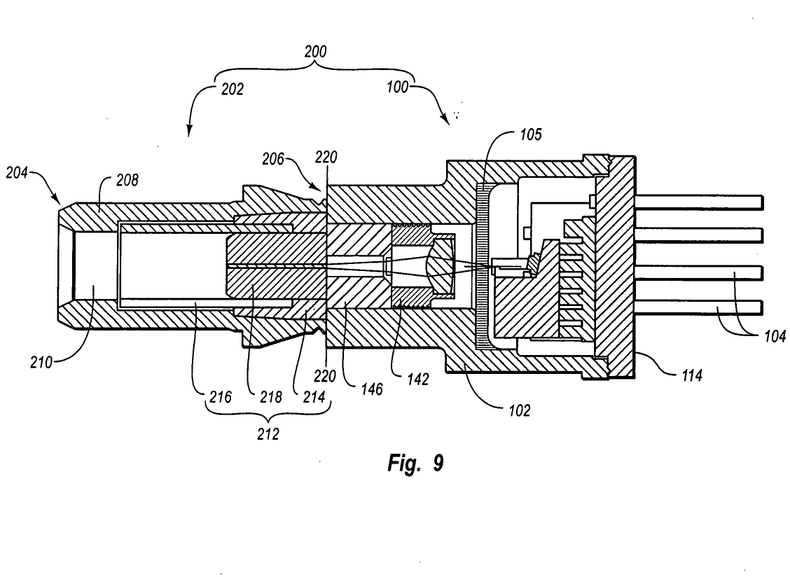

Turning now to FIG. 9, packaging assembly 100 can be used to form an optical subassembly 200. As shown in FIG. 9, optical subassembly 200 includes packaging assembly 100 connected to a nose assembly 202. Since packaging assembly 100 can be substantially similar to the embodiments described above, like elements will be referred to with like reference numbers. The packaging assembly 100 includes an isolator 146 disposed in portion 136 of header can 102.

Generally, nose assembly 202 comprises a front end 204 and a back end 206. The nose assembly 202 is generally configured to receive a terminal portion of an optical fiber at a front end 204 of the nose assembly 202. The nose assembly 202 may include one or more bushings (not shown) positioned proximate the front end 110, which are configured to cooperate with the nose assembly 202 to receive and hold the optical fiber therein. The back end 206 of nose assembly 202 is configured to connect to packaging assembly 100. The nose assembly 202 generally includes an elongated housing 208 having a longitudinal channel 210 formed therethrough. The housing 208 is made from a relatively hard material, for example 416 stainless steel. Other hard materials may be used such as metal or plastic.

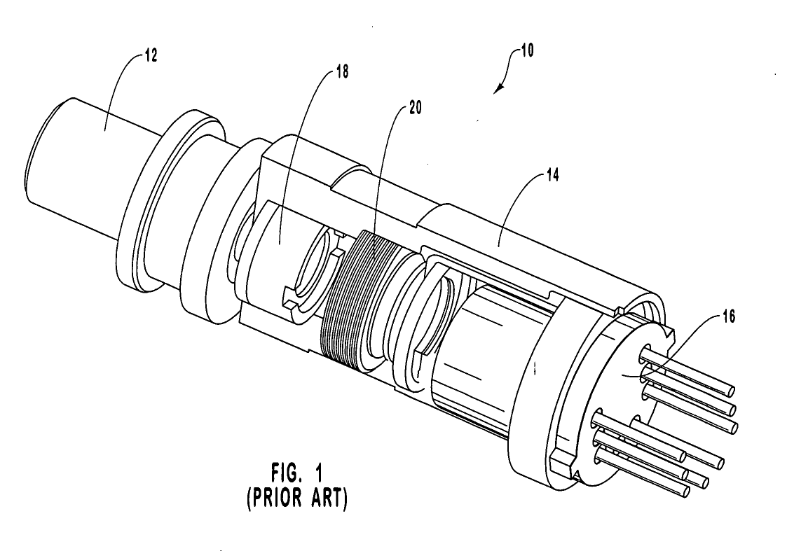

As shown in FIG. 1, the nose assembly 202 further includes a fiber retaining r<assembly 212 configured to be disposed in the back end 120 of the nose assembly 202. In one embodiment, fiber retaining assembly 212 can be configured to be secured inside the housing 208 primarily by friction fit, as will be described further below. As such, no epoxy may be required in order to assemble the nose assembly 202, thus greatly decreasing the manufacturing cost and time required to produce the nose assembly. In one embodiment, shown in FIG. 9, the fiber retaining assembly 212 includes a tapered ring 214, a split sleeve ring 216, and a fiber stop 218 positioned near the back end 206 of the nose assembly 202. Suitable embodiments for manufacturing nose assembly 202 are discussed in more detail in U.S. Provisional Patent Application No. 60/553,770, filed Mar. 17, 2004 and entitled “Nose Assembly for Optical Device,” already incorporated herein by reference.

Significantly, it will be appreciated that header can 200 does not have to be shaped to be disposed in any particular structure in order to be connected to nose assembly 202. This reduces the step of having to shape header can 200 into any particular design. Thus, the header can 200 can be shaped in any design that allows the back end 206 of nose assembly 202 to abut the end of header can 200. As shown in FIG. 9, nose assembly 202 and header can 200 can be welded at interface 220 using laser welding. Other connecting means may be used including, but not limited to, soldering, adhesive, and the like. In addition, simple connecting means eliminate additional components that are required in order to connect header cans to nose assemblies. It will thus be appreciated that the present invention reduces the time and cost of manufacturing of optical subassemblies.

When comparing the embodiment of FIG. 9 with the conventional optical subassembly shown in FIG. 1, it becomes apparent that one novel aspect of the present invention is substituting the housing 14 with the header can 102. That is, header can 102 is configured to house isolator 18, lens 20 and, of course, the optical device. This serves to eliminate additional parts and manufacturing steps.

During assembly, front end 204 of nose assembly 202 will be connected to the terminal end of a fiber optic cable (not shown). Light to and/or from the end of the fiber optic cable (not shown) is transmitted through fiber stop 218 to the header can 102. Inside the header can 102, the light is transmitted to and/or from isolator 146 and, subsequently, to and/or from lens 142. Finally, light is transmitted from the lens 142 to and/or from window 105 to the optical device located on the header structure 101. The header structure 101 converts the light signals into electrical signals and vice versa. The electrical signals are transmitted to and/or from a printed circuit board (not shown) via leads 104.

The present invention allows for packaging assemblies 100 to be produces which may be even smaller than conventional packaging assemblies. According to one embodiment, the diameter of the second portion 136 of header can 102 can be smaller than about 0.295 inch. The height of the header can 102 can be smaller than about 0.225 inch. When the header can 102 is mated with the header structure 101, the resulting packaging assembly 100 may have a height of approximately 0.265 inch, excluding the leads 104.

While less preferred, it is possible that the packaging assembly 100 has the same size as a conventional transistor outline package and the header can 102 has the same size as the header can of a conventional transistor outline package for a laser diode or photo-diode. Thus, the packaging assembly 100 according to the present invention can be fitted within optoelectronic transceiver or transmitter modules that are constructed according to standardized form factor requirements.

Thus, in view of these dimensions, a transceiver or transmitter module including the packaging assemblies of the present invention can have the following dimensions: width, about 3 cm or less; length, about 6.5 cm or less, and height, about 1.2 cm or less. A GBIC standard (SFF-8053 GBIC standard version 5.5) requires the dimensions of a module housing to be approximately 3 cm×6.5 cm×1.2 cm. Thus, the transceiver or transmitter module of this embodiment meets the form factor requirements of the GBIC standard.

In another embodiment, the physical dimensions of a module including the packaging assemblies of the present invention are: width, about 0.54 inch or less; length, about 2.24 inches or less; and height, about 0.105 inch or less. The SFP MSA (Small Form Factor Pluggable Multisource Agreement) requires the dimensions of a compliant module housing to be approximately 0.54″×2.24″×0.105.″ Thus, the module can also meet the form factor requirements of the SFP standard.

Note that the present invention is not limited to the form factor requirements described above. A person of ordinary skill in the art having the benefit of this disclosure will appreciate that the present invention is adaptable to various existing or yet to be determined transceiver or transmitter module form factors, some of which can be smaller or larger.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A packaging assembly, comprising:
a header can;
a header structure;
an optical device attached to the header structure; and
at least one of a window or a lens situated in the header can,
wherein the header can and the header structure are actively aligned so that the optical device is aligned with the at least one window or lens.

2. A packaging assembly as recited in claim 1, wherein the header can comprises a first mating portion and the header structure comprises a second mating portion, wherein the first mating portion and the second mating portion are configured to selectively mate together.

3. A packaging assembly as recited in claim 1, wherein the header can and header structure are joined by resistance projection welding.

4. A packaging assembly as recited in claim 1, wherein the header can and header structure are hermetically sealed.

5. A packaging assembly as recited in claim 1, wherein the at least one of a window or a lens comprises a lens for transmitting and collimating an optical signal emitted by the optical device.

6. A packaging assembly as recited in claim 2, wherein the lens is situated near the center of the header can.

7. The packaging assembly as recited in claim 1, further comprising a temperature measuring device mounted close to the optical device, wherein the temperature measuring device is operable to measure temperature of the optical device.

8. The packaging assembly as recited in claim 1, wherein the housing has a first portion and a second portion, wherein the first portion has a larger diameter than the second portion.

9. The packaging assembly as recited in 8, wherein the second portion is configured to house the at least one of a window or a lens.

10. The packaging assembly as recited in 8, wherein the second portion is configured to house an isolator.

11. The packaging assembly as recited in claim 1, wherein the header can and the header structure are made of a thermally conductive material.

12. The packaging assembly as recited in claim 1, wherein the header can is made of a material comprising stainless steel 304L.

13. An optical subassembly comprising:
a nose assembly configured to receive a terminal end of an optical fiber, the nose assembly having a front end and a back end; and
a packaging assembly comprising:
a header can having a first end and a second end;
a header structure having a base structure configured to attach to the second end of the header can;
an optical device attached to the header structure; and
at least one of a window or a lens situated in the header can,
wherein the back end of the nose assembly is connected to the first end of the header can.

14. The optical subassembly as recited in claim 13, wherein the header can and the header structure are actively aligned before joining.

15. The optical subassembly as recited in claim 13, wherein the header can comprises a first mating portion and the header structure comprises a second mating portion, wherein the first mating portion and the second mating portion are configured to selectively mate together.

16. A packaging assembly as recited in claim 13, wherein the header can and header structure are joined by resistance projection welding.

17. A packaging assembly as recited in claim 13, wherein the header can and header structure are hermetically sealed.

18. A packaging assembly as recited in claim 13, wherein the at least one of a window or a lens comprises a lens for transmitting and collimating an optical signal emitted by the optical device.

19. The packaging assembly as recited in claim 13, wherein the housing has a first portion and a second portion, wherein the first portion has a larger diameter than the second portion.

20. The packaging assembly as recited in 20, wherein the second portion is configured to house the at least one of a window or a lens.

21. The packaging assembly as recited in 20, wherein the second portion is configured to house an isolator.

22. The packaging assembly as recited in claim 13, wherein the header can is made of a material comprising stainless steel 304L.

23. The packaging assembly as recited in claim 13, wherein the nose assembly and the packaging assembly are connected by at least one of laser welding, soldering, or adhesive.
